(19) United States
(12) Patent Application Publication
(10) Pub. No.: US 2004/0164973 A1
(43) Pub. Date: Aug. 26, 2004

(54) Personal digital assistant and program for controlling used for the same

(75) Inventors: Masao Nakano, Yokohama-shi (JP); Masao Nakazawa, Yokohama-shi (JP); Yoshio Sasaki, Yokohama-shi (JP); Eiji Takeuchi, Yokohama-shi (JP); Yosuke Miho, Yokohama-shi (JP); Hajime Ishikawa, Yokohama-shi (JP); Takeo Kobayashi, Yokohama-shi (JP); Tomoki Myoi, Yokohama-shi (JP); Hiroshi Kasakawa, Yokohama-shi (JP); Akiko Watanabe, Yokohama-shi (JP); Shinsuke Sato, Yokohama-shi (JP)

Correspondence Address: SCHULTE ROTH & ZABEL LLP, 919 Third Avenue, New York, NY, 10022, US

(73) Assignee: KYOCERA CORPORATION

(21) Appl. No.: 10/609,770

(22) Filed: Jun. 27, 2003

(30) Foreign Application Priority Data
Jun. 28, 2002 (JP) 2002-191123
Jul. 30, 2002 (JP) 2002-221743

(51) Int. Cl. G09G 5/00

(52) U.S. Cl. 345/184

(57) ABSTRACT

A side controller supported so as to be capable of oscillating within a predetermined range and capable of pushing is disposed on the side face of a PDA, a current page displayed on a display part is controlled to scrolled in a first direction by oscillating operation of the side controller, a current page is transferred to a predetermined processing mode to display a screen page corresponding to the processing mode by prolonged pushing operation of the side controller for a time longer than a predetermined time, a current page is transferred to a screen page other than a predetermined screen page, for example, a current page is transferred to a processing mode unrelated to a operating button displayed on the current page, for prolonged pushing operation of the side controller long time, further, a list of reply mail sentences which is input beforehand is displayed as a screen page of a list of reply mail sentences by activation of a sending mode for sending a reply mail to a received mail when a mail screen page showing received mail is displayed, a pointer is moved on a screen page of a list of sending mail sentences by oscillating operation of the control switch part, a sending mail sentence on which a pointer is positioned is transmitted to a mail sending and receiving function as a sending mail, for example, a list of sending mail screen page in a sending mode is displayed by pushing operation of the control switch part for a time longer than a predetermined time when a mail screen page is a mail contents displaying screen page for showing a mail contents.

### BACKGROUND OF THE INVENTION

I. Field of the Invention

The present invention relates to a personal digital assistant (PDA) having enhanced operationality, particularly to a personal digital assistant receiving e-mails as received e-mails while sending e-mails as sent e-mails and storing received e-mails, and a program for controlling used for the same.

II. Description of the Related Art

Generally, in an information processing apparatus such as an information terminal, an apparatus which executes a processing corresponding to an input position (item) detected on a touch panel by pen touch inputting is known. Further, there is an apparatus provided with a switch capable of operating independently of the touch panel in order to enhance operationality so as to control displaying a screen page by switch operation. Since a PDA is used in mobile environment such as out of office, it's operation needs to be simple so that a screen page is controlled to display by switch operation.

For example, Japanese patent publication JP10-240693A (hereinafter referred to as a prior art) discloses a compact information processing apparatus in which menu items displayed on a screen page are scrolled by rotating operation of a rotary switch, a menu item is selected by pushing operation of the rotary switch and a content of a screen page is changed by rotating and pushing operation, at the same time, of the rotary switch. A power source of the PDA is on and off by prolonged pushing operation of the rotary switch for a predetermined time.

Further, Japanese patent publication JP2002-55767A discloses an information inputting apparatus in which after one group is selected among a plurality of groups, a character is selected by rotating operation of a rotating dial. When the rotating dial is operated again, the selected character is input. In Japanese patent publication JP2002-99380A, it is described that an application is executed by pushing an operating part after selecting the application by rotating the operating part.

Apparatuses having an operating part such as a switch capable of rotating and pushing, which is thereby operated are disclosed in Japanese patent publication JP2000-32112A, JP 10-155020A and 2001-274889A.

In the aforementioned prior art, it is nothing but one pushing operation is assigned as a selecting action after scrolling by rotating operation of the rotary switch. That is to say, it is nothing but a pointed item is selected by pushing the rotary switch after a screen page is scrolled. Other operation on the screen page needs to be done by means other than the rotary switch such as touch operation so that the rotary switch cannot be used for other operations.

Though, in the prior art, it is described that a power source is on and off when the rotary switch is pushed for a predetermined time (prolonged pushing), that is not an operation on a screen page.

As for switching operation of rotating or pushing described in other publications, only scrolling and selecting operation is available on a screen page similarly with the aforementioned prior art but the rotary switch is not used for other operations.

On the other hand, there is a personal digital assistant having a function that e-mails are sent as sending e-mails and e-mails are received as receiving e-mails for storing by connecting to a communication device such as a cellular phone. There is an information terminal which has a function of sending a mail to a received mail (reply mail).

Japanese patent publication JP2000-3316A (hereinafter referred to as a prior art 1) discloses a mail apparatus for easily creating reply mails and sending mails when sending a reply mail to a received mail. In the prior art 1, when a received mail is opened, whose content is displayed on a mail window and an automatic reply mail selecting button of “yes”, which is displayed on a command bar in the window, is touched, a reply mail which is added on the head of the received mail by reading out an affirmative message stored precedently is generated to display. And transmitting is performed as a sending address of a received mail is designated.

Similarly, when an automatic reply mail selecting button of “no” is touched, a reply mail which is added on the head of the received mail by reading out an denial message stored precedently is generated to display so as to transmit.

In Japanese patent publication JP2000-40042A (hereinafter referred to as a prior art 2), when e-mails are transferred, a list of received e-mails and information regarding transferring addresses are displayed as icons. E-mails are transferred to addresses of received mails by selecting received e-mails and repeating drug and drop to icons of transferring addresses.

In Japanese patent publication JP2002-91871A (hereinafter referred to as a prior art 3), a method is described, whereby a reply mail is sent only by one button operation without making a document of reply mail at the recipient side. A received mail is analyzed so as to generate a reply mail by stylized forms, which is sent as an e-mail.

In addition, in Japanese patent publication JP10-27141A (hereinafter referred to as a prior art 3), when a recipient of an e-mail creates a reply mail, the recipient selects a reply from a list of replies and combines a received mail with the selected reply so as to send the reply mail. In Japanese patent publication JP5-7221A, it is described that when a user selects a document from a list of documents, an address for a reply mail is picked up from management information of the document to display on a screen page on which a reply mail document is written and select send so as to send the reply mail.

Although a stylized form is used for generating a reply mail in the above-mentioned prior arts 1-4, a reply mail document is generated by pen touch operation, which needs both hands. An information terminal used in mobile environment such as a PDA is operated with a hand unavailable, for example, when a user brings luggage or holds a strap so that pen touch, which needs both hands is difficult to operate in most cases. As a result, there is a problem that it is difficult that a reply mail is easily generated and sent.

Further, since, when a user is walking, it is difficult to send a reply mail by pen touch operation, the user needs to stop walking so that problem is operationality is bad.

### SUMMARY OF THE INVENTION

An object of the present invention is to provide a personal digital assistant having excellent operationality by capacitating a rotary switch for operation of a screen page other than scrolling and selecting. Another object of the present invention is to provide a portable information terminal and a control program capable of sending a mail regarding a received mail with ease and excellent operationality.

According to the present invention, a personal digital assistant comprises: a control switch part capable of oscillating or rotating and pushing operation; a display part capable of displaying a first screen page for displaying a plurality of items, a second screen page corresponding to each item of a plurality of the items and a third screen page other than the first screen page; a first selecting control means for selecting an item from a plurality of the items by oscillating or rotating operation of the control switch part on the first screen page; a first page transfer means for transferring to the third screen page by pushing operation of the control switch part for a time longer than a predetermined time on the first screen page; and a second page transfer means for transferring to the second screen page corresponding to the selected item by pushing operation of the control switch part for a time not longer than a predetermined time on the first screen page.

According to the present invention, a personal digital assistant comprises: a control switch part capable of oscillating or rotating and pushing operation; a display part capable of displaying a menu screen page for displaying a plurality of menu items, a menu item screen page corresponding to each menu item of a plurality of the menu items and an unrelated screen page; a menu selecting control means for selecting a menu item from a plurality of the menu items by oscillating or rotating operation of the control switch part on the menu screen page; an unrelated screen page transfer means for transferring to the unrelated screen page which is not related to the selected menu item by pushing operation of the control switch for a time longer than a predetermined time on the menu screen page; a menu item screen page transfer means for transferring to the menu item screen page corresponding to the menu item by pushing operation of the control switch part for a time not longer than a predetermined time on the menu screen page.

According to the present invention, a personal digital assistant comprises: a control switch part capable of oscillating or rotating and pushing operation; a display part capable of displaying a mail list screen page for displaying a mail list, a mail contents screen page for displaying each mail contents of the mail list screen page and a reply mail screen page for a reply mail to each mail of the mail list screen page; a mail selecting control means for selecting one mail from the mail list screen page by oscillating or rotating operation of the control switch part on the mail list screen page; a reply mail screen page transfer means for transferring to a reply mail screen page corresponding to the selected mail by pushing operation of the control switch part for a time longer than a predetermined time on the mail list screen page; and a mail contents transfer means for transferring to a mail contents screen page corresponding to the selected mail by pushing operation of the control switch part for a time not longer than a predetermined time on the mail list screen page.

According to the present invention, a personal digital assistant comprises: a control switch part capable of oscillating or rotating and pushing operation; a display part capable of displaying a file list screen page for displaying a file list, a file activated screen page for displaying each activated file of the file list screen page and a file detailed information screen page for displaying a more detailed file information in comparison to the file list screen page; a file selecting control means for selecting one file from the file list screen page by oscillating or rotating operation of the control switch part on the file list screen page; a file detailed information screen page transfer means for transferring to a file detailed information screen page by pushing operation of the control switch part for a time longer than a predetermined time on the file list screen page; and a file activated screen page transfer means for transferring to a file activated screen page on which the selected file is activated by pushing operation of the control switch part for a time not longer than a predetermined time on the file list screen page.

According to the present invention, a personal digital assistant comprises: a control switch part capable of oscillating or rotating and pushing operation; a display part capable of displaying a tab screen page for displaying a plurality of tabs, another tab screen page corresponding to each tab of a plurality of the tabs; a setting item selecting control means for selecting a setting item of the tab screen page by oscillating or rotating operation of the control switch part on the tab screen page; a tab screen page transfer means for transferring to another tab screen page by pushing operation of the control switch part for a time longer than a predetermined time on the tab screen page; and a tab selecting control means for selecting sequentially a plurality of the tabs by pushing operation of the control switch part for a time not longer than a predetermined time on the tab screen page.

According to the present invention, the control switch part is capable of oscillating operation within a predetermined range and capable of pushing operation at an approximately center position of the oscillating range.

According to the present invention, the control switch part and an escape switch part are disposed at the side face of the personal digital assistant and a screen page returning control means for returning to one page previous to the current page by operation of the escape switch part is provided.

According to the present invention, a personal digital assistant having a communicating function therein or a mail sending and receiving function for sending and receiving mails by connecting to an external communicating instrument comprises: a control switch part capable of oscillating or rotating and pushing operation; a illustrative sentences displaying control means for displaying a plurality of predetermined illustrative sentences for a sending mail; and a sending mail sentence determining means for determining the selected sending mail sentence by pushing operation of the control switch part after selecting a sending mail sentence from a plurality of the illustrative sentences for a sending mail by oscillating operation of the control switch part.

According to the present invention, a personal digital assistant further comprises a mail selecting means for selecting a mail from a plurality of received mails by operation of the control switch part and an sending address determining means for determining a sender's address of the received mail selected by the mail selecting means as a sending address, wherein the mail sending and receiving function sends a mail according to a sending address and a sending mail sentence determined by the sending address determining means and the sending mail sentence determining means.

According to the present invention, a personal digital assistant further comprises a received mail displaying means for displaying a received mail contents among a plurality of received mails by operation of the control switch part, wherein the mail selecting means selects a received mail from a plurality of received mails by pushing operation of the control switch part on a screen page on which the display part displays a mail contents by the received mail displaying means and the sending mail address determining means determines a sender's address of the selected received mail as a sending address.

According to the present invention, a personal digital assistant sends automatically a mail having a sending mail sentence determined by pushing operation of the control switch part when determined by the sending mail sentence determining means.

According to the present invention, a personal digital assistant having a communicating function therein or a mail sending and receiving function for sending and receiving mails by connecting to an external communicating instrument comprises a control switch part capable of oscillating or rotating and pushing operation, wherein: a received mail is selected from one or more received mails by operation of the control switch part; a sender's address is determined as a sending address by pushing operation of the control switch part after selecting the receive mail; a plurality of predetermined illustrative sentences for a sending mail are displayed on a display part; an illustrative sentence for a sending mail is selected from a plurality of the predetermined illustrative sentences for a sending mail by oscillating or rotating operation of the control switch part; and the selected illustrative sentence for a sending mail is determined for sending a mail to the determined sending address as a sending mail sentence.

According to the present invention, a control switch part is disposed on a side face of a case of the personal digital assistant and is supported so as to be capable of oscillating or rotating around a predetermined axis and pushing to the direction of approximately orthogonal to the axis.

According to the present invention, a program for controlling used for a personal digital assistant having a communicating function therein or a mail sending and receiving function for sending and receiving mails by connecting to an external communicating instrument comprises a illustrative sentences displaying control step of displaying a plurality of predetermined illustrative sentences for a sending mail on a display part and a sending mail sentence determining step of determining the selected illustrative sentence for a sending mail as a sending mail sentence by pushing operation of the control switch part after selecting an illustrative sentence for a sending mail from a plurality of the illustrative sentences for a sending mail by oscillating or rotating operation of a control switch part which is capable of oscillating or rotating and pushing operation.

According to the present invention, a program for controlling used for a personal digital assistant having a communicating function therein or a mail sending and receiving function for sending and receiving mails by connecting to an external communicating instrument comprises: a selecting step selecting a received mail from one or more received mails by operation of a control switch part which is capable of oscillating or rotating and pushing operation; a determining and displaying step of determining a sender's address of received mail as a sending address by pushing operation of the control switch part after selection and displaying a plurality of predetermined illustrative sentences for a sending mail; and a sending mail sentence determining step of selecting an illustrative sentence for a sending mail from a plurality of the illustrative sentences for a sending mail by oscillating or rotating operation of the control switch part and determining a selected illustrative sentence for a sending mail as a sending mail sentence for sending to the determined sending address by pushing operation of the control switch part.

### BRIEF DESCRIPTION OF THE DRAWINGS

FIG. 1 is a perspective view showing an external appearance of one embodiment of a personal digital assistant according to the present invention.

FIG. 2 is a block diagram showing one embodiment of a control system used for the personal digital assistant shown in FIG. 1.

FIG. 3 is a schematic drawing showing a launcher screen page for one embodiment of a current screen page.

FIG. 4 is a flow chart illustrating a control by operation of a side controller on the personal digital assistant shown in FIG. 1.

FIG. 5 is a schematic drawing showing one embodiment of a received mail list screen page on the personal digital assistant shown in FIG. 1.

FIG. 6 is a schematic drawing showing one embodiment of a screen page of a received mail contents displayed on the personal digital assistant shown in FIG. 1.

FIG. 7 is a schematic drawing showing one embodiment of a screen page of an easy reply mail screen page displayed on the personal digital assistant shown in FIG. 1.

FIG. 8 is a schematic drawing showing one embodiment of a screen page of a list of file information displayed on the personal digital assistant shown in FIG. 1.

FIG. 9 is a schematic drawing showing one embodiment of a setting tool screen page displayed on a personal digital assistant shown in FIG. 1.

FIG. 10 is a schematic drawing showing one embodiment of a setting tool screen page changed by a side controller in FIG. 9.

FIG. 11 is a schematic drawing showing one embodiment of a list page of newly arrived mails displayed on a personal digital assistant shown in FIG. 1.

FIG. 12 is a schematic drawing showing one embodiment of an easy reply mail screen page (a case of a user defined sentence mode) displayed on a personal digital assistant shown in FIG. 1.

FIG. 13 is a schematic drawing showing one embodiment of an easy reply mail screen page (a case of text input) displayed on a personal digital assistant shown in FIG. 1.

FIG. 14 is a schematic drawing showing one embodiment of a mail top screen page displayed on a personal digital assistant shown in FIG. 1.

FIG. 15 is a flow chart illustrating action of an easy reply mail.

### DETAILED DESCRIPTION

The invention will now be described in detail by way of example with reference to the accompanying drawings. It should be understood, however, that the description herein of specific embodiments such as to the dimensions, the kinds of material, the configurations and the relative disposals of the elemental parts and the like is not intended to limit the invention to the particular forms disclosed but the intention is to disclose for the sake of example unless otherwise specifically described.

First Embodiment

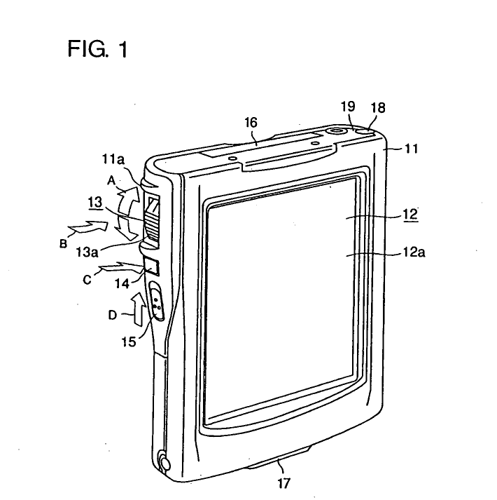

A personal digital assistant shown in FIG. 1 (PDA) is as large as a user can hold in his or her palm of the hand. A liquid crystal panel 12 having a touch panel 12a is provided throughout nearly all of the front face of a case 11 (The touch panel 12a is disposed, for example, on the surface of the liquid crystal panel 12.). Further, as described later, a control switch (hereinafter referred to as a side controller) 13, an escape switch 14, a power source on-off switch (hereinafter referred to as a power switch) 15, an insert slot 16 into which an external memory medium such as a memory card, a communication device such as a communication card or an external device such as an external hard disc is inserted, an external connection terminal 17 used for communication of a variety of data with a personal computer or power charging, and a storage part 19 for storing a touch pen (a stylus pen) 18 are provided on the case 11.

As shown in FIG. 1, the side controller 13, the escape switch 14 and the power switch 15 are disposed from top to down in this sequence on the side face of the case 11. The side controller is disposed so as to have a possibility that the side controller 13 touches the thumb of the left hand when the case is held by user's left hand so that the liquid crystal panel 12 faces in front of the user.

A protruded part 11a extending toward outer direction is formed at the upper part of the side controller 13. A part of the side controller 13 is exposed from the side face of the case 11. The side controller 11 is supported by an axis (unshown) extending from the anterior (front) to the back face of the case 11 so as to be capable of oscillating or rotating in the direction shown by a solid arrow A (up and down direction) in the figure within a predetermined range and to be capable of pushing in the direction orthogonal to the axis (in the direction from the lateral side to the inside of the figure)(in the direction of the solid arrow B) The range of rotation (oscillation) is restricted within the range capable of rotating (oscillating) operation by nearly one upward push or downward push with a thumb of the left hand. Wave formed protrusions 13a are formed on the exposed surface of the side controller 13.

The side controller 13 is rotated (oscillated) or pushed, for example, by a thumb of the left hand. The thumb of the left hand touches the protrusion 13a in this regard. The side controller 13 stays at a predetermined position (hereinafter referred to as a standard position) under the condition of non-operation. When it is pushed upward from the standard position with a thumb of the left hand, the side controller 13 is rotated (oscillated) by predetermined rotating amount and is not rotated (oscillated) more. When the thumb is released from the side controller 13 (i.e., a force to rotate (oscillate) is removed), the side controller 13 returns to the standard position (approximately center position of the range of rotating amount) by itself. Identically, when it is pushed upward from the standard position with a thumb of the left hand, the side controller 13 is rotated (oscillated) by predetermined rotating amount and is not rotated (oscillated) more. When the thumb is released from the side controller 13, the side controller 13 returns to the standard position by itself. Though pushing operation can be carried out only at the standard position, it is possible to design to be capable of pushing at the top and the bottom position of oscillating range.

Since the side controller returns to the standard position when the thumb is released from the side controller 13, oscillating is easy to operate. In addition, since pushing operation is always carried out at the standard position, pushing is also easy to operate. Further, oscillating operation restricted within a predetermined oscillating range allows an operating thumb for an extreme small necessary distance of movement as compared with the conventional rotating operation of such as a dial which is possible to rotate about one round. As a result, a burden of a thumb is greatly reduced so that the apparatus according to the present invention has good operationality.

With regard to operation of the aforementioned rotatable dial, right after the dial is fully rotated to the right, for example, with a thumb, pushing with the same thumb is difficult to operate so that the thumb needs to be moved to the approximate center position of the dial. As for pushing operation of the side controller 13, operationality is extremely good in comparison to pushing operation of the rotatable dial. The side controller 13 sends an operating signal corresponding to the oscillating or pushing operation. A various processes are executed according to the signal as stated later.

The escape switch 14 is disposed at the lower part of the side controller 13; the power switch 15 is disposed at the lower part of the escape switch; a plurality of dot like protrusions are formed on the surface of the power switch. In addition, these side controller 13, escape switch 14, power switch 15 are disposed at the position capable of operating, for example, by a thumb of, for example, the left hand. In the example shown in the figure, the escape switch 14 is pushed (the solid arrow C) so as to send an escape signal and, as described later, to execute an escape operation. The power switch 15 is operated by sliding operation (the solid arrow D). When the power switch 15 is slid upward, as shown in the figure, power is on and the power switch 15 returns to the initial position and again when the power switch is slid upward at the state of power on, power is off and the power switch 15 returns to the initial position.

With the external connection terminal 17, the PDA shown in the figure can be connected to a charging device (so called a cradle device) having a communication function so as to communicate data with personal computers. The liquid crystal panel 12 is, for example, a color liquid crystal display provided with a backlight. The touch panel 12a has touch sensors, which detect touch positions and touch lines when touched (tapped) with a touch pen 18.

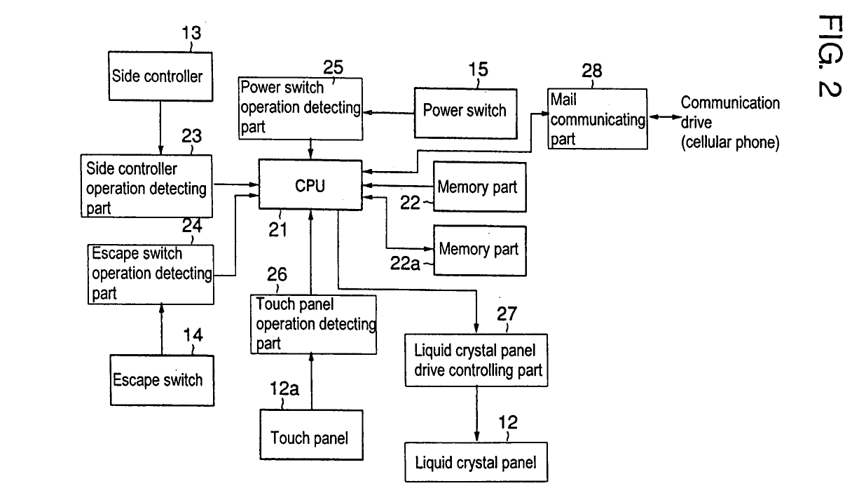

Referring to FIG. 2, a PDA has an central processing unit (CPU) 21 which controls the entire PDA in accordance with control programs stored in a memory part 22 such as ROM and executes a variety of processes, which is described later, in accordance with application programs. Application programs are downloaded from an external memory medium inserted in the insert slot 16 or from outside by communication as the case may be. A memory part 22a capable of writing or reading, which consists of such as RAMs is connected to the CPU 21. (A content stored to the memory part does not disappear even if power is off.)

As shown in FIG. 2, a side controller 13 is connected to the CPU 21 through a side controller operation detecting part 23; an escape switch 14 is connected to the UPU through an escape switch operation detecting part 24; a power switch 15 is connected to the CPU 21 through a power switch operation detecting part 25; a touch panel 12 is connected to the CPU 21 through a touch panel operation detecting part 26; and a liquid crystal panel 12 is connected to the CPU 21 through a liquid crystal panel operation detecting part 27.

The PDA shown in FIG. 2 has a mail communicating part (a mail communicating function) 28 (it may be provided to a communication card inserted in the insert slot 16), which is connected to the CPU 21. The mail communication part 28 sends or receives mails through communication devices such as cellular phones or communication cards. Every time when a mail is received or sent, the CPU 21 stores the received or sent mail to the memory part. The stored received or sent mails can be read out from the memory part 22a to consult.

In the state that power of the PDA is off, when the power switch 15 is slid upward, a power switch operation detecting part 25 detects the sliding operation to send a power switch operating signal to the CPU 21. Corresponding to the power switch operating signal, the CPU 21 activates the PDA to the state of power on. When power is on, CPU 21 displays an initial screen page (a menu screen page, hereinafter referred to as a launcher screen page), which is one of application programs on the liquid crystal panel 12 by controlling to drive a liquid panel drive controlling part 27.

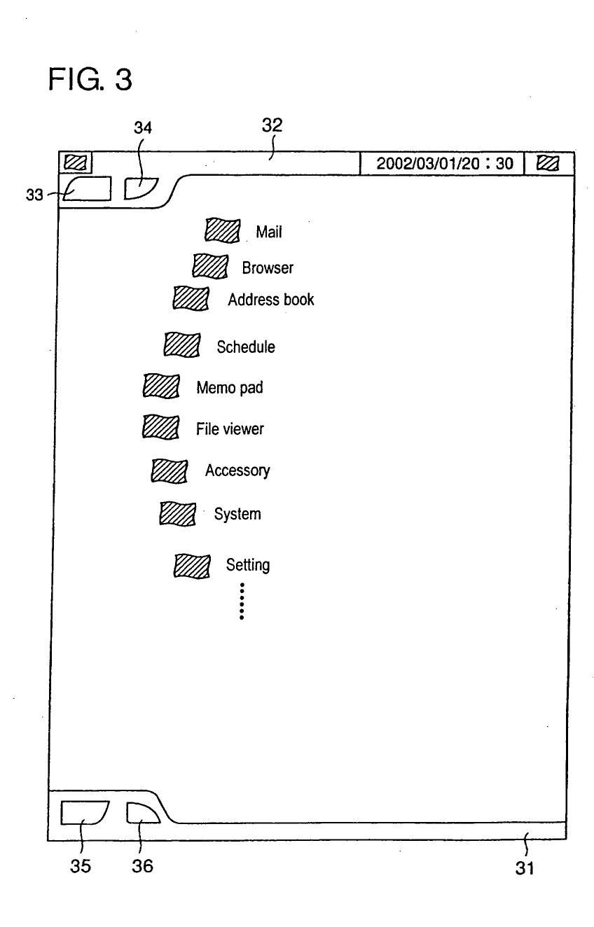

As shown in FIG. 3, menu items (selection items) such as mail, browser, address book, schedule, memo pad, file viewer, accessory, system and setting are displayed together with icons on the launcher screen page. That is to say, an application program (an application software) concerning these menu items is stored in the memory part 22. A task bar 31 is displayed on the lower section of the launcher screen page and a title bar 32 is displayed on the upper section of the launcher screen page. Further, a scroll button (an upper scroll button) 33 and a screen page color changing button (an upper screen page color changing button) 34 are displayed on the upper-left section of the launcher screen page and a scroll button (a lower scroll button) 35 and a screen page color changing button (a lower screen page color changing button) 36 are displayed on the lower-left section of the launcher screen page.

As the cursor cannot be scrolled further upper section when the cursor (focus) is positioned to the most upper menu item on the screen page, the upper scroll button 33 is not displayed on the launcher screen page. Likewise, the lower scroll button 35 is not displayed on the launcher screen page when the cursor is positioned to the lowest menu item on the screen page.

If the upper scroll button 33 is touched (tapped) with the touch pen 18, a touch panel operation detecting part 26 detects the tap operation for CPU 21 to move the cursor to the one upper line on the screen page. That is, one touch of the upper scroll button makes the cursor transfer to one upper line of the menu item presently positioned.

Likewise, if the lower scroll button 35 is touched (tapped) once with the touch pen 18, the cursor is transferred to one lower line of the menu item presently positioned. Further, if the upper or lower screen page color changing button 34 or 36 is tapped, a screen page color of the launcher screen page is changed every time of tap operation so that a screen page color of the liquid crystal panel 12 can be varied. If one of menu items is touched with the touch pen 18, an application program corresponding to the menu item is activated to display the screen page concerning the menu item.

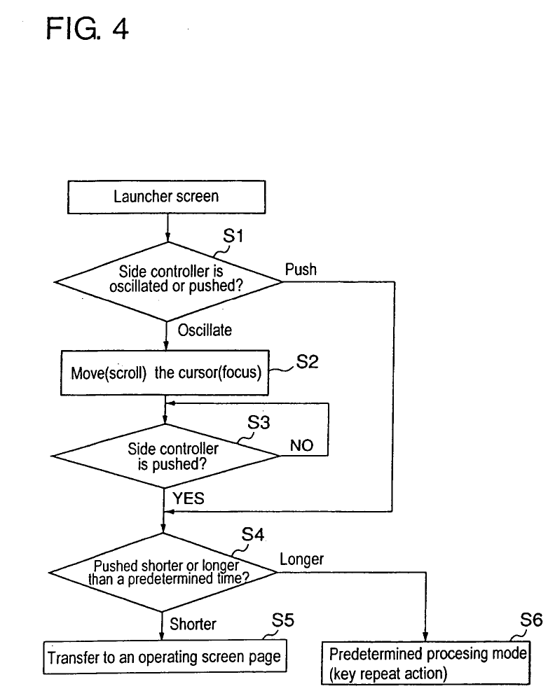

Referring to FIG. 3 and FIG. 4, operation by the side controller 13 at the state that a launcher screen page is displayed on the liquid crystal panel 21 is now explained. As a side controller operation detecting part 23 detects whether the side controller 13 is oscillated or pushed (step S1), the side controller operation detecting part 23 sends an oscillation detecting signal as an operating signal to the CPU 21, when the side controller 13 is oscillated. Thus, the CPU 21 moves (scrolls) the cursor (step S2).

When the side controller 13 is oscillated upwardly from the standard position, a side controller operation detecting part 23 detects the upward operation to send an upward operation signal to the CPU 21. The CPU 21 moves the cursor to the upper line on the launcher screen page by this signal. When the side controller 13 is oscillated downwardly from the standard position, a side controller operation detecting part 23 detects the downward operation to send an downward operation signal to the CPU 21. The CPU 21 moves the cursor to the lower line on the launcher screen page by this signal.

As stated above, the cursor can be positioned to a desired menu item among a plurality of menu items of operating buttons.

The side controller operation detecting part 23 detects whether the side controller is pushed or not (step S3). When side controller 13 is pushed, side controller operation detecting part 23 detects whether it is a short pushing operation for a time shorter than a predetermined time or it is a prolonged pushing operation for a time longer than a predetermined time (step S4). In case of short pushing operation of the side controller 13, the side controller operation detecting part 23 detects the short pushing operation to send a short pushing signal to the CPU 21. The CPU 21 selects by this signal a menu item where the cursor resides so as to activate an application program corresponding to the selected menu item and transfer to an operating screen page corresponding to the menu item (step S5).

Meanwhile, when the side controller 13 is pushed for a prolong time, the side controller operation detecting part 23 detects the prolonged pushing operation to send a prolonged pushing signal to the CPU 21. By this signal, the CPU 21 displays a screen page on the liquid crystal panel 12 irrespective of the menu item where the cursor resides, the screen page corresponding to a key repeat action for repeating key, which is a predetermined processing mode (step S6). Though the screen page is not shown particularly, it is a screen page for setting or changing a predetermined time for key repeat action, which is the time while key repeat is not carried out until after a predetermined time from a beginning of various operation of the side controller 13 or touch operation.

In step S1, if the side controller is pushed, then step is transferred to S4. And if, in step S4, a short pushing operation is detected, an application program corresponding to the menu item on which the cursor is positioned when a launcher screen page is activated is activated. If, in step S4, a prolonged pushing operation is detected, step is transferred to key repeat action as mentioned above.

Thus, when a launcher screen page is a presently displayed screen page, CPU 21 controls to scroll the presently displayed screen page in the up and down direction in answer to oscillating operation of the side controller 13. When the side controller is pushed for a short time, CPU 21 activates an application program corresponding to a menu item of a operating button on which the cursor is positioned or transfers the launcher screen page to a screen page corresponding to a menu item on which the cursor is positioned. When the side controller is pushed for a long time, CPU 21 transfers the launcher screen page to a predetermined processing mode irrespective of the menu item on which the cursor is positioned, for example, to a key repeat mode. A predetermined processing mode may be a processing mode other than a key repeat mode.

Though a screen page control by the side controller in case of a launcher screen page as a presently displayed screen page is explained above, the same is in case of other operating screen page by oscillating or short pushing operation of the side controller 13, it may be possible to activate other processing application corresponding to the displayed item or to transfer to other processing mode or other displayed item by a prolonged pushing operation of the side controller 13.

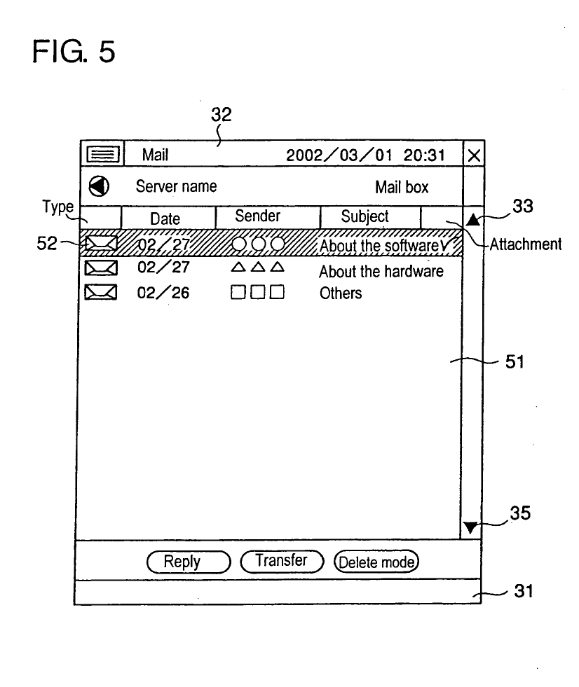

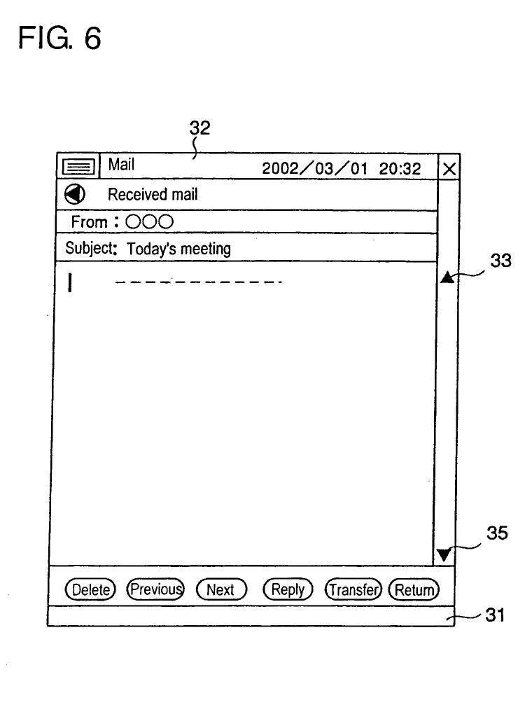

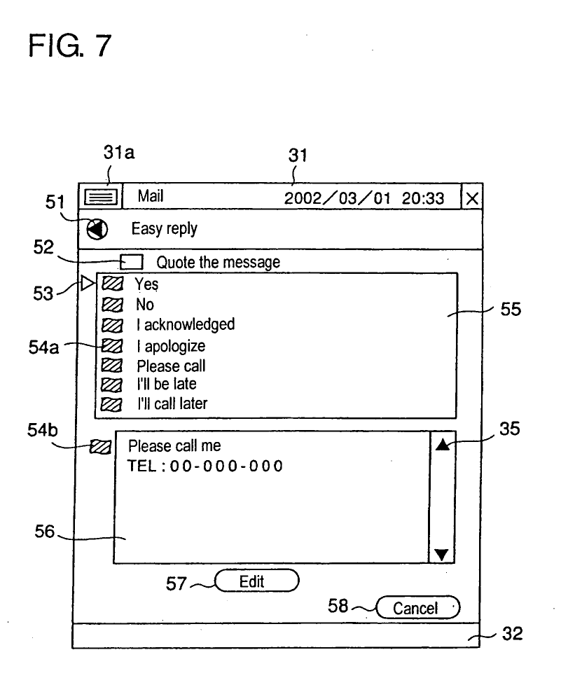

For example, when the side controller 13 is oscillated on a received mail list screen page shown in FIG. 5 as a presently displayed screen page, the CPU 21 moves the cursor (focus) 52 to a desired received mail on the received mail list screen page 51 and the CPU 21 transfers a screen page to a screen page displaying contents of the desired received mail, on which the cursor 52 shown in FIG. 6 is positioned, by short pushing operation of the side controller 13. By short pushing operation of the side controller 13 on the screen page displaying contents of the received mail, the page is transferred to a screen page displaying the next contents of the received mail desired on the received mail list screen page. By prolonged pushing operation of the side controller 13 on the screen page displaying contents of the received mail, the page is automatically transferred to a reply mail mode so as to activate a reply mail application to transfer to a reply mail screen page shown in FIG. 7. In this case, by prolonged pushing operation of the side controller 13, the CPU 21 transfers to a mode related to a displayed content, activates a related application or transfers to a related other screen page.

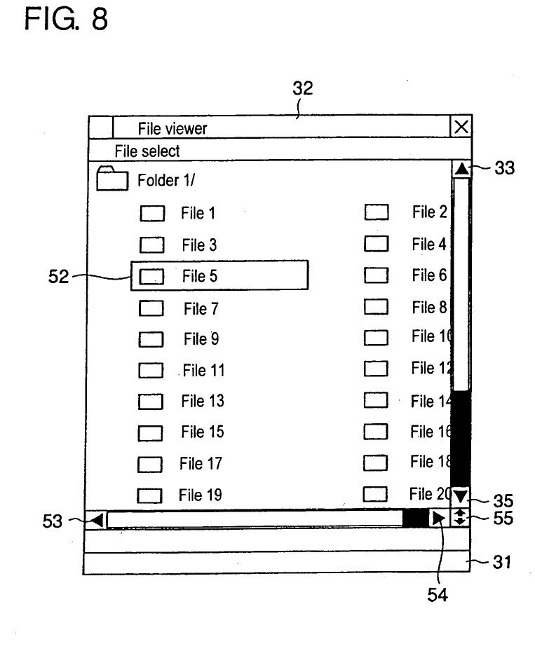

A cursor moves on a file information list screen page by oscillating operation of the side controller (scroll control) when a presently displayed screen page is a screen page displaying a file information shown in FIG. 8 by activating an application such as a file viewer. A direction of scroll by the side controller 13 is changed to horizontal or vertical by prolonged pushing operation of the side controller 13. Reference number 53 and 54 denote a left scroll button and a right scroll button respectively. Reference number 55 denotes a scroll direction changing button. A file on which a cursor resides is activated by short pushing operation of the side controller 13.

It may be possible to design in such a manner that, on a file list screen page shown in FIG. 8, a cursor moves up and down (scroll control) by oscillating operation of the side controller 13 the cursor moves toward left by short pushing operation of the side controller 13, and a file on which the cursor resides is activated by prolonged pushing operation of the side controller 13.

Referring to the same FIG. 8, it may be possible to design in such a manner that: a cursor moves in a sequence such as file 1, file 3, file 5, file 19, file 2, file 4, file 6 by oscillating operation of the side controller 13; a file on which the cursor resides is activated by short pushing operation of the side controller 13; and a file information list screen page shown in FIG. 8 is transferred, by prolonged pushing of the side controller 13, to a detailed file information list screen page displaying even attribute information of each file. On this screen page are displayed not only file names shown in FIG. 8 but also file sizes and kinds of files at the same time.

Again referring to the same FIG. 8, it may be possible to design in such a manner that: a cursor moves in a sequence such as file 1, file 2, file 5, file 4 by short pushing operation of the side controller 13; a file on which the cursor resides is activated by prolonged pushing of the side controller 13.

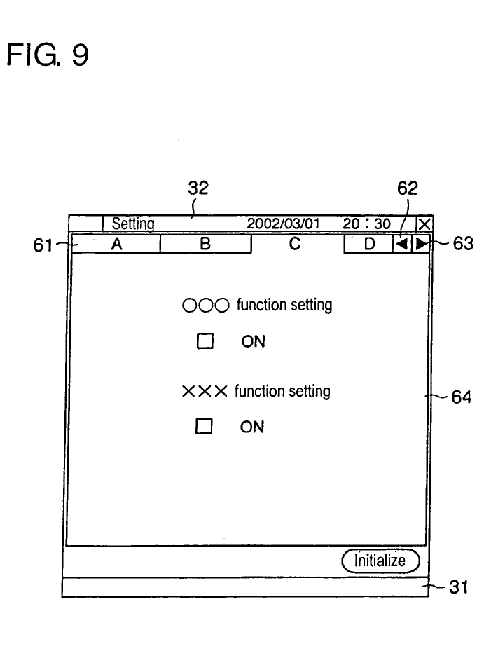

Referring to a tab screen page of FIG. 9, a tab is changed by short pushing operation of the side controller 13 when the cursor is on the position of tab 61. After that, i.e. after a tab is selected, when the side controller is rotated (oscillated) downward, the cursor moves to □ON position which sets ON or OFF of function setting of, for example, ooo on a setting tool screen page as shown in FIG. 9. When the side controller 13 is pushed for a short time with the cursor on the position of □ON, denotation changes from □ON to ▪ON and function setting of □ON is set to ON. After that, the side controller 13 is rotated yet downward, the cursor moves to yet lower □ON position for setting function of xxx Here likewise, a function of xxx can be set by short pushing operation of the side controller 13.

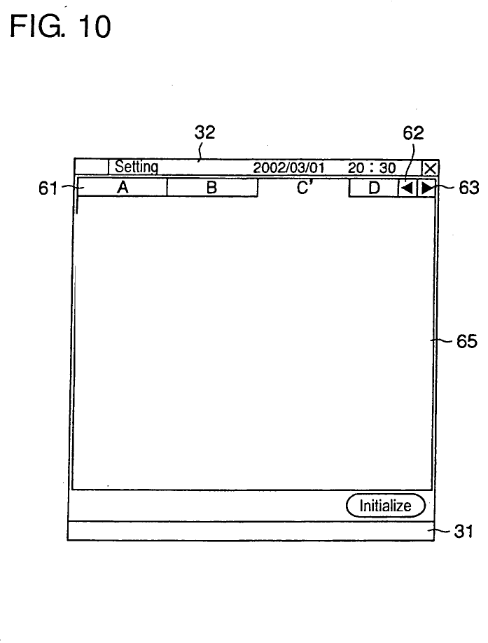

Further, when a setting application is activated on a launcher screen page, a setting screen page is displayed. When a setting tool is selected and activated by operation of the side controller or tap operation, a setting tool screen page is displayed shown in FIG. 9. When a setting tool screen page is a current page, tab 61 is changed sequentially every time when the side controller is pushed for a short time. Reference numbers 62 and 63 are changing buttons for changing a tab to right or left direction respectively. When tab “C” is selected as shown in FIG. 9, a setting tool screen page 64 corresponding to the tab “C” is displayed. When the side controller 13 is pushed for a prolonged time here, a screen page is changed to a screen page, for example, shown in FIG. 10. The screen page shown in FIG. 10 is a setting tool screen page 65 of tab “C” positioned next to a setting tool screen page 64 shown in FIG. 9 in relation to tab “C”, which is a more detailed screen page of the setting tool page shown in FIG. 9. At the state of FIG. 10, when the side controller 13 is pushed for a prolonged time, the page is transferred to a setting tool screen page of tab “D”. Meanwhile, when the side controller 13 is pushed for a prolonged time at the sate shown in FIG. 10, the page is transferred to a further detailed setting tool screen page of tab “C”.

In this manner, in addition to scroll control by oscillating operation of the side controller 13, various operations such as activation of an application corresponding to the file of an item on which a cursor is positioned, transfer to a screen page corresponding to the file of an item on which a cursor is positioned, transfer of tag, and transfer of a current page of file contents to a page of next file contents are possible by short pushing operation of the side controller. Further, various operations such as change of a scroll direction of scroll control, transfer to a processing mode irrespective of the item where the cursor is positioned on the current page, transfer to a mode related to presently displayed contents, activation of related application, and transfer to other related screen page are possible by prolonged pushing operation of the side controller 13, which results in good operationality of a PDA used in a mobile environment. Furthermore, since, in the above example, the side controller 13, the escape switch 14, and the power switch 15 are disposed on the side face of the case, the side controller 13, the escape switch 14, and the power switch 15 can be operated with a single hand, which also leads to good operationality.

Since apparent from the above explanation, The CPU 21 functions here as a scroll control means, processing mode transfer means, a screen page transfer means and return control means.

In this manner, since a current page displayed on the display part is controlled to scroll in a first direction by oscillating operation of the control switch part supported so as to be capable of oscillating within a predetermined range and capable of pushing; a current page is transferred to a predetermined processing mode to display a screen page corresponding to the processing mode by prolonged pushing operation for a time longer than a predetermined time; and a current page is transferred to a screen page other than the predetermined screen page, good operationality can be obtained in mobile environment.

As a plurality of operating buttons displayed on a current page is disposed along a first direction that is an oscillating direction of the control switch part, a focus is moved to the first direction by oscillating operation of the control switch part, and a screen page is transferred to a screen page corresponding to a operating button where the focus is positioned so that a direction of the control switch coincides with moving direction of focus, a user can operate easily as a result to enhance operationality.

Further, as a screen page is transferred to a predetermined processing mode irrespective of a operating button, it can be transferred to a processing mode other than the operating buttons set on the current page only by operation of the control switch part, which leads to good operationality.

As a control switch part is supported to an axis extending in a predetermined direction so as to be capable of oscillating around the axis with in a predetermined range from a predetermined standard point and to be capable of pushing in the direction orthogonal to the oscillating direction, a display part is provided on the approximately all of the front face of a case of the personal digital assistant, and a control switch part is disposed on the side face of the case of the personal digital assistant in the predetermined direction from the front face to the back face of the personal digital assistant, a user can operate the control switch part with a single hand, which leads to good operationality.

In addition, as an escape switch is provided at the under part of the control switch on the side face of the case of the personal digital assistant and a power witch is disposed at the under part of the escape switch so as to return a page to the current page by pushing the escape switch, the control switch part, escape switch and the power switch can be operated by a single hand and furthermore a page returns to the current page (a page previous to the transferred page), return to the current page is easily performed.

Second Embodiment

In a second embodiment of the present invention described below, constitutions of apparatuses and restricted conditions described by and shown in FIGS. 1, 2 and 3 in the first embodiment are the same as in the second embodiment unless otherwise specifically described. The explanation done in the first embodiment is to be replaced in the second embodiment as far as FIGS. 1, 2 and 3 are concerned, though the explanation in the second embodiment for these figures is omitted.

Likewise to the first embodiment, menu items (selection items) shown in FIG. 3 such as mail, browser, address book, schedule, memo pad, file viewer, accessory, system and setting are displayed together with icons on the launcher screen page. That is to say, an application program (an application software) concerning these menu items is stored in the memory part 22. A tool bar is displayed on the lower section of the launcher screen page and a date and time is displayed as useful information on the upper section of the launcher screen page.

When the side controller 13 is oscillated upwardly from the standard position, a side controller operation detecting part 23 detects the upward operation to send an upward operation signal to the CPU 21. The CPU 21 moves the cursor to the upper line on the launcher screen page by this signal. When the side controller 13 is oscillated downwardly from the standard position, a side controller operation detecting part 23 detects the downward operation to send an downward operation signal to the CPU 21.

The CPU 21 moves the cursor to the lower line on the launcher screen page by this signal.

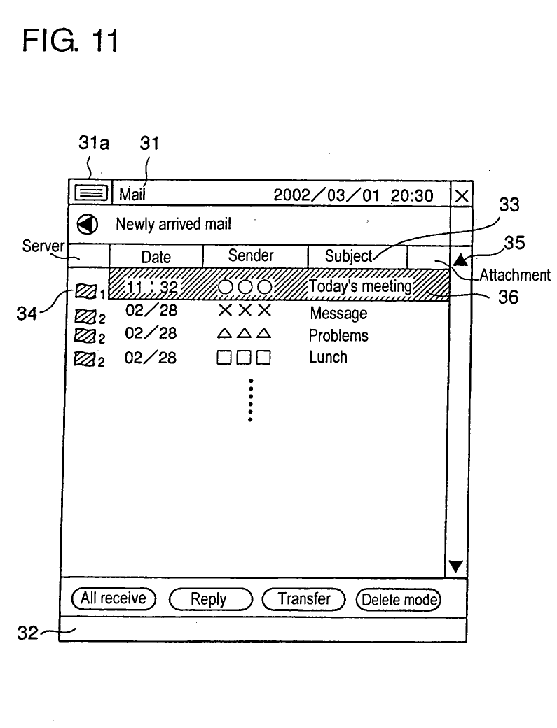

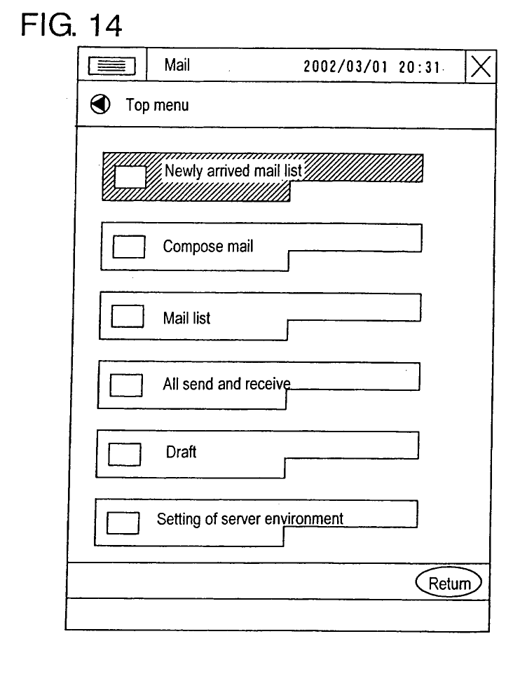

When a mail is selected and activated on the launcher screen page here by tap operation or side controller operation, a mail top screen page shown in FIG. 14 is displayed. The mail top screen page has “list of newly arrived mails”, “composing mail”, “list of mails”, “all send and receive”, “draft” and “setting of server environment”. If “list of newly arrived mails” is selected and activated by tap operation or side controller operation, a CPU 21 displays a screen page of a list of newly arrived mails shown in FIG. 11 on a liquid crystal panel 12. Newly arrived mails and unread mails are displayed on the screen page of a list of newly arrived mails.

As shown in FIG. 11, a title bar 31 and a task bar 32 are displayed on a screen page of a list of newly arrived mails and further an attribute information displaying column 33 is further defined thereon, in which an attribute information 34 of every newly arrived mail is displayed.

If, after a cursor 36 is moved to focus an attribute information 34 corresponding to a desired newly arrived mail on a screen page of a list of newly arrived mails by tapping operation of a scroll button 35 or by oscillating operation of the side controller 13 (hereinafter the newly arrived mail corresponding to the focused attribute information is referred to simply as a selected mail), a menu button 31a in the title bar 31, that is “mail”—“easy reply mail”, is tapped, the CPU 21 displays a screen page of an easy reply mail on the liquid crystal panel 12.

Meanwhile, when a mail list screen page is selected and activated on the mail top page by tap or side controller operation, the CPU 21 displays a mail list screen page on the liquid crystal panel 12. On the screen page of a list of mails, received mails, sent mails/reserved sending mails and draft mails are selectively displayed. That is, if a “received mail box” is selected on the screen page of a list of mails, the aforementioned list of attribute information for every mail regarding all received mails is displayed; if a “sending mail box” is selected, the aforementioned list of attribute information for every mail regarding all sent mails/reserved sending mails is displayed; and if a “draft” is selected, the aforementioned list of attribute information for every mail regarding all drafts mails.

In FIG. 5 is shown a received mail list screen page displayed on the liquid crystal panel 12 (this received mail list screen page is an e-mail screen page). A title bar 31 and a task bar 32 are displayed and further an attribute information displaying column 33 is defined on the received mail list screen page, similarly to the newly arrived mail list screen page explained in FIG. 11. In the attribute information displaying column 33 is displayed attribute information 34 of every received mail.

When “mail”—“easy reply mail” is tapped by tapping operation of the menu button 31a in the title bar after a cursor 36 is moved for focusing attribute information 34 corresponding to a desired received mail by tapping on a scroll button 35 or by oscillating the side controller 13 (hereinafter the received mail corresponding to the focused attribute information is referred to also as a selected mail similarly to a newly arrived mail corresponding to the focused attribute information on a newly arrived mail list screen page), the CPU 21 displays an after-mentioned easy reply mail screen page (a sending mail list screen page) on the liquid crystal panel 12.

When a user wants to consult a received mail on the received mail list screen page, the side controller 13 is pushed after a cursor is moved to a desired mail by oscillating the side controller 13 or by tapping the attribute information 34 of a desired mail. Then, the CPU 21 displays contents of the selected mail on the liquid crystal panel 12. For example, the CPU 21 displays a mail displaying screen page (received mail mode) shown in FIG. 6.

As shown in FIG. 6, a title bar 31 and a task bar 32 are displayed and further a mail contents displaying region 41 is defined on a mail displaying screen page. The contents of the selected mail is displayed in the mail contents displaying region 41.

When a user replys a mail from the mail displaying screen page, a tap operation which holds tapped state for a time longer than a predetermined time (herein after referred to as a prolonged tap operation) or a pushing operation for a time longer than a predetermined time (herein after referred to as a prolonged pushing operation) is performed. The CPU 21 displays a easy reply mail screen page on the liquid crystal panel 12 by this operation.

If the side controller 13 is simply pushed in this mail displaying screen page, contents of a next mail of the displayed mail, i.e. a mail next to the selected mail in the mail list screen page is displayed on the mail displaying screen page.

As stated above, when a menu button is tapped to select “mail”—“easy reply mail”, a mail content displaying region on the mail displaying screen page is tapped for a prolonged time or the side controller 13 is pushed for a prolonged time after selecting an address to which a reply mail is sent by a selection of selecting mail on the newly arrived mail list screen page or the mail list screen page, the CPU 21 displays an easy reply mail screen page on the liquid crystal panel 12. Hence, a screen page can be transferred from a launcher screen page to an easy reply mail screen page only by operation of the side controller if transferring to an after-mentioned easy reply mail screen page through a mail displaying screen page.

In other words, a screen page is transferred to an easy reply mail screen page if the following steps is sequentially performed, the steps of selecting a mail by operation of the side controller 13 after displaying a launcher screen page, selecting a newly arrived mail list or a mail list on a mail top screen page by the side controller 13, selecting a desired mail as a selected mail by operation of the side controller 13, displaying a mail displaying screen page by side controller and pushing the side controller for a prolonged time. Thus, an operation to call an easy reply mail screen page is possible with a single hand operating the side controller 13.

Referring to FIG. 7, a return icon 51, a check box 52, pointer (cursor) 53, an easy reply mail button for standard sentences 54a, an easy reply mail button for user standard sentences 54b, a text field 55, a user defined sentences displaying region 56, an edit button 54, and a cancel button 58 as well as a title bar 31 and a task bar are displayed in an easy reply mail screen page.

When the return icon 51 is tapped in the easy reply mail screen page, a screen page is returned to the most recently displayed screen page on the liquid crystal panel 12. This screen page transfer is performed also when an escape switch is pushed. When the check box 52 is checked, a quoted sentence is added to a message body of the mail. As this is not concerned with the present invention, explanation is omitted. The pointer 53 is moved up and down in the page by oscillating operation of the side controller 13.

And then a user positions the pointer 53 to a desired reply mail sentence (a predetermined standard sentence). Predetermined standard sentences are displayed in the text field 55. Further, user defined sentences that the user has edited and input beforehand are displayed in the user defined sentences displaying region 56. User defined sentences can be edited by tapping the edit button 57 as mentioned later. A screen page is returned to the most recently displayed screen page on the liquid crystal panel 12 by tapping the cancel button 58.

If a reply mail is sent by selecting a standard sentence in the text field 55, UPU 21 sent a standard sentence as a reply mail to the mail sending receiving part 28 by tapping the easy reply mail button 54a corresponding to the desired standard sentence. In this occasion, a sender's address of the selected mail is sent to the mail sending receiving part 28. And, the mail sending receiving part 28 sends automatically a reply mail sentence as a reply mail to the sender's address.

Meanwhile, the CPU 21 displays a sending dialog (box) on the liquid crystal panel 12. When sending is finished, the CPU 21 closes the easy reply mail screen page to transfer to display a newly arrived mail list page or a mail list page.

Similarly, when a reply mail is sent by selecting a user defined sentence as a reply mail sentence, as mentioned later, the CPU 21 sends the defined sentence to the mail sending receiving part 28 by user's tapping the easy reply mail button after a user creates the defined sentence beforehand. And as mentioned before, the mail sending receiving part 28 sends the reply mail sentence as a reply mail to the sender's address.

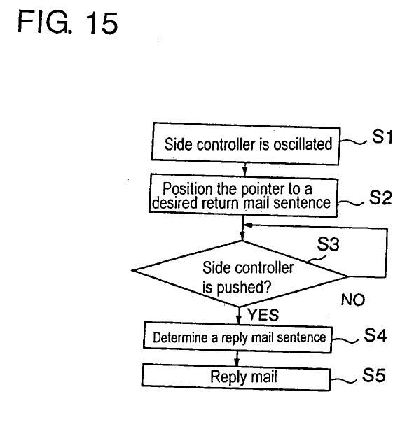

An operation for sending a reply mail from the easy reply mail screen page can be executed by the side controller 13. Referring to FIG. 15, when the side controller is oscillated (rotated) (step S1), the pointer 53 moves to each left side position of the check box 52, the text field 55, the easy reply mail button 54a and the easy reply mail button 54b of the user defined sentences displaying region 56 in the up and down direction of the screen page in answer to the oscillating operation.

And, when the side controller 13 is pushed (step S3) after a user positions the pointer 53 to a desired reply mail sentence on the text field 55 or the user defined sentence displaying region 56 (step S2), the CPU 21 sends the standard sentence or the defined sentence as a reply mail sentence to the mail sending receiving part 28 (step S4).

And as mentioned above, the mail sending receiving part 28 sends the reply mail sentence as a reply mail to the sender's address through a communication instrument (step S5). Thus, the side controller operation detecting part send a selecting signal to the CPU 21 by pushing operation of the side controller 13 so that the CPU 21 automatically sends the reply mail by selecting as a reply mail the standard sentence or the defined sentence on which pointer is positioned.

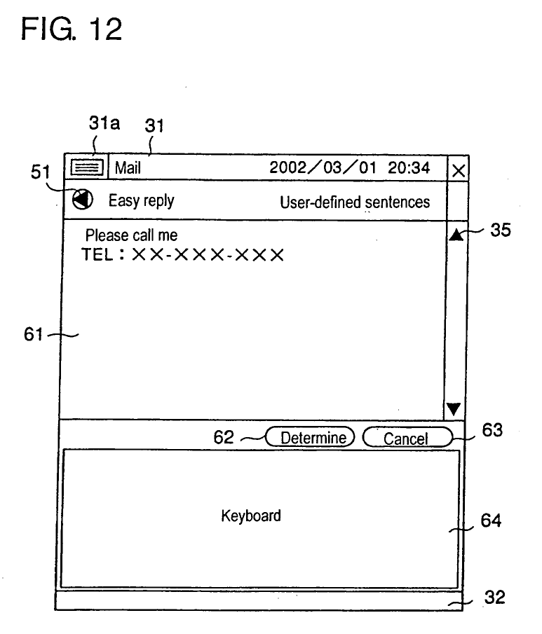

The edit button is tapped in case of editing a user-defined sentence on the easy reply mail screen page. The CPU 21 transfers a page to the easy reply mail screen page (a user defined sentence editing mode) shown in FIG. 12. A user-defined sentence inputting area 61 is defined on the easy reply mail screen page and a determining button 62 and a cancel button 63 is displayed. Further, a keyboard 64 is displayed under the determining button 62 and the cancel button 63. And, by tapping the keyboard 64 for inputting characters, the input sentence is displayed on the user-defined sentence inputting area 61 to be a user-defined sentence. When the determining button 62 is tapped after inputting a user-defined sentence, the CPU 21 determines the user-defined to store in the memory part 22a and the easy reply mail screen page is displayed on the liquid crystal panel 12. In this occasion, a user-defined sentence is displayed on the user-defined sentence displaying region 56.

When the cancel button 63 is tapped, the CPU 21 stops to edit the user-defined sentence to display the easy reply mail screen page shown in FIG. 7 on the liquid crystal panel 12. In this occasion, a user-defined sentence stopped to edit is not displayed in the user defined sentence region 56. The aforementioned standard sentences are stored in, for instance, the memory part 22a.

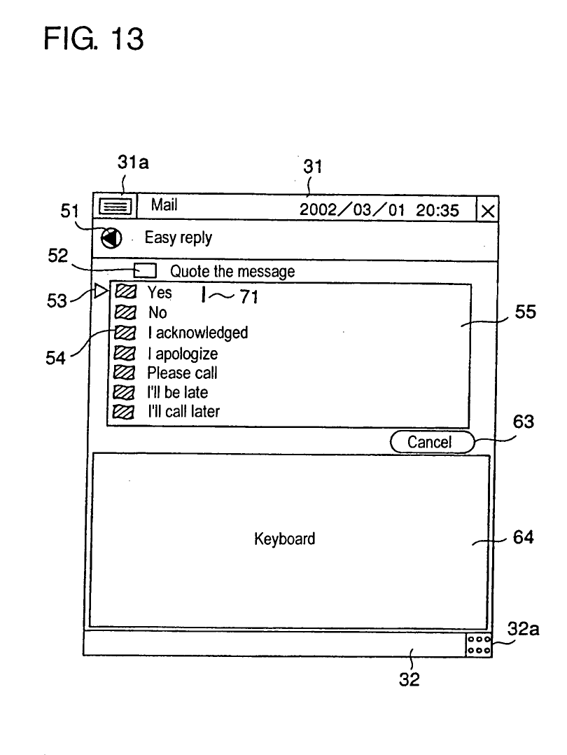

A standard sentence displayed on the aforementioned text field 55 can be edited. In this occasion, when a keyboard button 32a in the task bar 32 is tapped on the FIG. 13, the keyboard 64 is displayed, as shown in FIG. 13. When a desired standard sentence is tapped, a cursor 71 appears on the standard sentence. When characters are input by tapping the keyboard 64, the standard sentence is edited.

The standard sentence thus edited is stored in the memory part 22a while executing an easy reply mail, tapping the return icon 51 or pushing the escape switch 14.

In this manner, a reply mail can be sent in answer to the selected mail only by pushing operation of the side controller 13 after selecting a reply mail by oscillating operation of the side controller 13 on the easy reply mail.

As apparent from the aforementioned explanation, a reply mail can be actually sent started from a launcher screen page only by operation of the side controller with a single hand so that operationality in mobile environment can be greatly enhanced.

As apparent from the aforementioned explanation, the CPU 21 functions as a sending mail sentence displaying control means, a sending control means and a contents displaying control means.

Since, when a sending mode for sending a reply mail in answer to the received mail is activated while a mail screen page which shows a received mail is displayed, a list of sending mails which is input in the display part before hand is displayed as a sending mail list screen page, a pointer is moved on the sending mail sentences list screen page by oscillating operation of the control switch part, and a sending mail sentence on which the pointer is positioned is sent as a sending mail, not only a sending mail is easily sent by operation of the control switch part but also operationality can be greatly enhanced.

Since the control switch part is disposed on the side face of the case of the personal digital assistant and is supported so as to be capable of oscillating around the axis parallel to the side face while capable of pushing to the direction orthogonal to the axis, the control switch part is operable with a single hand and operationality when sending a sending mail is enhanced.

Since the display part is disposed on approximately all part of the front face of the case of the personal digital assistant and the control switch part is disposed on the side face of the case of the personal digital assistant in the predetermined direction from the front face to the back face of the personal digital assistant, a user can operate the control switch part with a single hand while watching a screen page so that operationality of sending a mail is further enhanced.

Since a sending mail list screen page is displayed on the display part when the control switch part is pushed for a time longer than a predetermined time on the received mail screen page (mail content displaying screen page), a screen page is easily transferred to a sending mail mode to display a sending mail list screen page only by operation of the control switch part.

What is claimed is:

1. A personal digital assistant comprising:
a control switch part capable of oscillating or rotating and pushing operation;
a display part capable of displaying a first screen page for displaying a plurality of items, a second screen page corresponding to each item of a plurality of the items and a third screen page different from the first screen page;
a first selecting control means for selecting an item from a plurality of the items by oscillating or rotating operation of the control switch part on the first screen page;
a first page transfer means for transferring to the third screen page by pushing operation of the control switch part for a time longer than a predetermined time on the first screen page; and
a second page transfer means for transferring to the second screen page corresponding to the selected item by pushing operation of the control switch part for a time not longer than a predetermined time on the first screen page.

2. A personal digital assistant comprising
a control switch part capable of oscillating or rotating and pushing operation;
a display part capable of displaying a menu screen page for displaying a plurality of menu items, a menu item screen page corresponding to each menu item of a plurality of the menu items and an unrelated screen page;
a menu selecting control means for selecting a menu item from a plurality of the menu items by oscillating or rotating operation of the control switch part on the menu screen page;
an unrelated screen page transfer means for transferring to the unrelated screen page which is not related to the selected menu item by pushing operation of the control switch for a time longer than a predetermined time on the menu screen page; and
a menu item screen page transfer means for transferring to the menu item screen page corresponding to the menu item by pushing operation of the control switch part for a time not longer than a predetermined time on the menu screen page.

3. A personal digital assistant comprises:
a control switch part capable of oscillating or rotating and pushing operation;
a display part capable of displaying a mail list screen page for displaying a mail list, a mail contents screen page for displaying each mail contents of the mail list screen page and a reply mail screen page for a reply mail to each mail of the mail list screen page;
a mail selecting control means for selecting one mail from the mail list screen page by oscillating or rotating operation of the control switch part on the mail list screen page;
a reply mail screen page transfer means for transferring to the reply mail screen page corresponding to the selected mail by pushing operation of the control switch part for a time longer than a predetermined time on the mail list screen page; and
a mail contents transfer means for transferring to the mail contents screen page corresponding to the selected mail by pushing operation of the control switch part for a time not longer than a predetermined time on the mail list screen page.

4. A personal digital assistant comprising:
a control switch part capable of oscillating or rotating and pushing operation;
a display part capable of displaying a file list screen page for displaying a file list, a file activated screen page for displaying each activated file of the file list screen page and a file detailed information screen page for displaying a more detailed file information in comparison to the file list screen page;
a file selecting control means for selecting one file from the file list screen page by oscillating or rotating operation of the control switch part on the file list screen page;
a file detailed information screen page transfer means for transferring to the file detailed information screen page by pushing operation of the control switch part for a time longer than a predetermined time on the file list screen page; and
a file activated screen page transfer means for transferring to the file activated screen page on which the selected file is activated by pushing operation of the control switch part for a time not longer than a predetermined time on the file list screen page.

5. A personal digital assistant comprises:
a control switch part capable of oscillating or rotating and pushing operation;
a display part capable of displaying a tab screen page for displaying a plurality of tabs, another tab screen page corresponding to each tab of a plurality of the tabs;
a setting item selecting control means for selecting a setting item of the tab screen page by oscillating or rotating operation of the control switch part on the tab screen page;
a tab screen page transfer means for transferring to said another tab screen page by pushing operation of the control switch part for a time longer than a predetermined time on the tab screen page; and
a tab selecting control means for selecting sequentially a plurality of the tabs by pushing operation of the control switch part for a time not longer than a predetermined time on the tab screen page.

6. A personal digital assistant according to claim 1, 2, 3, 4, or 5, wherein the control switch part is capable of oscillating operation within a predetermined range and capable of pushing operation at an approximately center position of the oscillating range.

7. A personal digital assistant according to claim 1, 2, 3, 4, or 5, wherein the control switch part and an escape switch part are disposed at the side face of the personal digital assistant and a screen page returning control means for returning to one page previous to the current page by operation of the escape switch part is provided.

8. A personal digital assistant having a communicating function therein or a mail sending and receiving function for sending and receiving mails by connecting to an external communicating instrument comprises:
a control switch part capable of oscillating or rotating and pushing operation;
an illustrative sentences displaying control means for displaying a plurality of predetermined illustrative sentences for a sending mail; and
a sending mail sentence determining means for determining the selected sending mail sentence by pushing operation of the control switch part after selecting a sending mail sentence from a plurality of the illustrative sentences for a sending mail by oscillating or rotating operation of the control switch part.

9. A personal digital assistant according to claim 8, further comprises:
a mail selecting means for selecting a mail from a plurality of received mails by operation of the control switch part; and
an sending address determining means for determining a sender's address of the received mail selected by the mail selecting means as a sending address,
wherein the mail sending and receiving function sends a mail according to a sending address and a sending mail sentence determined by the sending address determining means and the sending mail sentence determining means.

10. A personal digital assistant according to claim 9, further comprises:
a received mail displaying means for displaying a received mail contents on the display part among a plurality of received mails by operation of the control switch part,
wherein the mail selecting means selects a received mail from a plurality of received mails by pushing operation of the control switch part on a screen page on which the display part displays a mail contents by the received mail displaying means and the sending mail address determining means determines a sender's address of the selected received mail as a sending address.

11. A personal digital assistant according to claim 8, 9 or 10, wherein the personal digital assistant sends automatically a mail having a sending mail sentence determined by pushing operation of the control switch part when determined by the sending mail sentence determining means.

12. A personal digital assistant having a communicating function therein or a mail sending and receiving function for sending and receiving mails by connecting to an external communicating instrument comprises:
a control switch part capable of oscillating or rotating and pushing operation, wherein:
a received mail is selected from at least one received mail by operation of the control switch part;
a sender's address of the selected received mail is determined as a sending address by pushing operation of the control switch part after selecting the received mail; a plurality of predetermined illustrative sentences for a sending mail are displayed on a display part;
an illustrative sentence for a sending mail is selected from a plurality of the predetermined illustrative sentences for a sending mail by oscillating or rotating operation of the control switch part; and
the selected illustrative sentence for a sending mail is determined for sending a mail to the determined sending address as a sending mail sentence by pushing operation of the control switch part.

13. A personal digital assistant according to claim 8, 9, 10 or 12, wherein the control switch part is disposed on a side face of a case of the personal digital assistant and is supported so as to be capable of oscillating or rotating around a predetermined axis and pushing to the direction of approximately orthogonal to the axis.

14. A program for controlling used for a personal digital assistant having a communicating function therein or a mail sending and receiving function for sending and receiving mails by connecting to an external communicating instrument comprising:
an illustrative sentences displaying control step of displaying a plurality of predetermined illustrative sentences for a sending mail on a display part; and
a sending mail sentence determining step of determining the selected illustrative sentence for a sending mail as a sending mail sentence by pushing operation of the control switch part after selecting an illustrative sentence for a sending mail from a plurality of the illustrative sentences for a sending mail by oscillating or rotating operation of the control switch part which is capable of oscillating or rotating and pushing operation.

15. A program for controlling used for a personal digital assistant having a communicating function therein or a mail sending and receiving function for sending and receiving mails by connecting to an external communicating instrument comprising:
a selecting step selecting a received mail from at least one received mail by operation of a control switch part which is capable of oscillating or rotating and pushing operation;
a determining and displaying step of determining a sender's address of received mail as a sending address by pushing operation of the control switch part after selection and displaying a plurality of predetermined illustrative sentences for a sending mail; and
a sending mail sentence determining step of selecting an illustrative sentence for a sending mail from a plurality of the illustrative sentences for a sending mail by oscillating or rotating operation of the control switch part and determining the selected illustrative sentence for a sending mail as a sending mail sentence for sending to the determined sending address by pushing operation of the control switch part.
